(19) United States
(12) Patent Application Publication
(10) Pub. No.: US 2017/0297532 A1
(43) Pub. Date: Oct. 19, 2017

(54) SMART KEY SYSTEM

(71) Applicant: DENSO CORPORATION, Kariya-city, Aichi-pref. (JP)

(72) Inventor: Masahito KOJIMA, Kariya-city (JP)

(21) Appl. No.: 15/517,687

(22) PCT Filed: Oct. 27, 2015
(86) PCT No.: PCT/JP2015/005391

§ 371 Date: Apr. 7, 2017

(30) Foreign Application Priority Data
Oct. 29, 2014 (JP) 2014-220638

(51) Int. Cl. B60R 25/24; E05B 81/54; G07C 9/00

(52) U.S. Cl. CPC B60R 25/245; G07C 9/00309; E05B 81/54; G07C 2009/00396

(57) ABSTRACT

A smart key system includes: a plurality of mobile devices each of which can be carried by a user, and is assigned unique identification information; and a control unit that is provided in an opening/closing body, performs an inquiry to the plurality of mobile devices by radio wave transmission, and locks or unlocks the opening/closing body when verification of the identification information responded from any of the mobile devices succeeds. The control unit performs simple verification for confirming presence or absence of the plurality of mobile devices within a response area, before verifying the identification information, and performs formal verification of the identification information for a mobile device that has been confirmed to be present by the simple verification, among the plurality of mobile devices.

### CROSS REFERENCE TO RELATED APPLICATION

This application is based on Japanese Patent Application No. 2014-220638 filed on Oct. 29, 2014, the disclosure of which is incorporated herein by reference.

### TECHNICAL FIELD

The present disclosure relates to a smart key system that locks or unlocks a key provided in an opening/closing body.

### BACKGROUND ART

A smart key system described in Patent Literature 1 for example is known as a conventional smart key system. In the smart key system (keyless system) in Patent Literature 1, an electric lock device first transmits a starting signal including a global ID intended for all mobile devices at the time of authenticating a plurality of mobile devices. At this time, if only one mobile device is present, interference between mobile devices does not occur, and it is possible to immediately verify (authenticate) identification information from the mobile device and reduce the time required for verification.

If a plurality of mobile devices are present, and verification is not established due to interference between mobile devices at the time of transmitting the starting signal including the global ID, the electric lock device transmits a starting signal including a unique ID to each mobile device in predetermined transmission order. Thus, in the presence of a plurality of mobile devices, it is possible to sequentially receive and verify identification signals responded from the mobile devices without causing interference between the mobile devices. The predetermined transmission order is set, for example, in such a manner that the mobile device having higher use frequency has higher priority in accordance with the past use frequency, or in such a manner that the mobile device that succeeded in the previous verification has higher priority.

### PRIOR ART LITERATURE

### Patent Literature

Patent Literature 1: JP 2008-150836 A

### SUMMARY OF INVENTION

However, in the smart key system in Patent Literature 1, consideration is given merely to the prioritization of all the mobile devices to be verified. For example, even if any of the plurality of mobile devices is absent at the place, verification is simply performed on all the mobile devices in sequence; therefore, time for verification is spent on the mobile device that is absent at the place, so that the total time until the completion of all verification cannot be reduced.

It is an object of the present disclosure to provide a smart key system that can reduce the total time until the completion of verification if any of a plurality of mobile devices to be verified is absent at the place.

According to a first aspect of the present disclosure, a smart key system includes: a plurality of mobile devices each of which can be carried by a user, and is assigned unique identification information; and a control unit that is provided in an opening/closing body, performs an inquiry to the plurality of mobile devices by radio wave transmission, and locks or unlocks the opening/closing body when verification of the identification information responded from any of the mobile devices succeeds. The control unit performs simple verification for confirming presence or absence of the plurality of mobile devices within a response area, before the verification of the identification information, and performs the verification of the identification information, as a formal verification, for a mobile device that has been confirmed to be present by the simple verification, among the plurality of mobile devices.

According to this configuration, the control unit first performs the simple verification, and thereby confirms the presence or absence of the plurality of mobile devices within the response area. Then, the control unit performs the formal verification of the identification information for the mobile device that has been confirmed to be present by the simple verification, among the plurality of mobile devices. Therefore, if there is a mobile device that is not present within the response area, a formal verification for the mobile device that is not present within the response area is omitted, and the verification time for that can be reduced, so that the total time until the completion of the verification can be reduced.

According to a second aspect of the present disclosure, a smart key system includes: a plurality of mobile devices each of which can be carried by a user, and is assigned unique identification information; and a control unit that is provided in an opening/closing body, performs an inquiry to the plurality of mobile devices by radio wave transmission, and locks or unlocks the opening/closing body when verification of the identification information responded from any of the mobile devices succeeds. Each of the plurality of mobile devices enables intercommunication by which a response content responded from another mobile device to the control unit is received. When the inquiry is made from the control unit, the plurality of mobile devices sequentially perform a simple response, to the control unit, indicating presence or absence within a response area, grasp by intercommunication a mobile device making no simple response, and perform a formal response to the inquiry in order in which the mobile device making no response is omitted.

According to this configuration, when the inquiry is made from the control unit, the plurality of mobile devices sequentially perform the simple response, to the control unit, indicating the presence or absence within the response area. Then, the plurality of mobile devices perform the formal response to the inquiry in the order in which the mobile device making no simple response, obtained based on intercommunication, is omitted. Therefore, if there is a mobile device that is not present within the response area, a formal verification for the mobile device that is not present within the response area is omitted, and the verification time for that can be reduced, so that the total time until the completion of the verification can be reduced.

According to a third aspect of the present disclosure, a smart key system includes: a plurality of mobile devices each of which can be carried by a user, and is assigned unique identification information; and a control unit that is provided in an opening/closing body, performs an inquiry to the plurality of mobile devices by radio wave transmission, and locks or unlocks the opening/closing body when verification of the identification information responded from any of the mobile devices succeeds. Each of the plurality of mobile devices enables intercommunication by which a response content responded from another mobile device to the control unit is received. Order of response is specified beforehand in such a manner that the plurality of mobile devices respond to the inquiry from the control unit, with a predetermined time difference. In a case where a mobile device that is lower in the order responds based on the order during a response of a mobile device that is higher in the order, the mobile device that is lower in the order waits for a predetermined time and then responds so as not to overlap with the mobile device that is higher in the order.

According to this configuration, the order of the responses of the plurality of mobile devices is specified. Therefore, if there is a mobile device that is not present within the response area, the response by the mobile device that is not present within the response area is automatically omitted, so that the total time until the completion of the verification can be reduced.

Further, when the mobile device that is lower in the specified order responds based on the order, and when the mobile device that is higher in the order is during the response, the mobile device that is lower in the order waits for the predetermined time and then responds so as not to overlap with the mobile device that is higher in the order. Therefore, the control unit can surely obtain the response result without interference between mobile devices.

### BRIEF DESCRIPTION OF DRAWINGS

The above and other objects, features and advantages of the present disclosure will become more apparent from the following detailed description made with reference to the accompanying drawings, in which like parts are designated by like reference numbers and in which:

FIG. 1 is a block diagram showing the configuration of a smart key system according to a first embodiment;

FIG. 2A is a time chart showing the correspondence between an inquiry of a vehicle control unit and a response of a mobile control unit in the case where the response of a first mobile device is present according to the first embodiment;

FIG. 2B is a time chart showing the correspondence between the inquiry of the vehicle control unit and the response of the mobile control unit in the case where the response of a fourth mobile device is present according to the first embodiment;

FIG. 3 is a flowchart showing control contents performed by the vehicle control unit according to the first embodiment;

FIG. 4A is a time chart showing the correspondence between the inquiry of the vehicle control unit and the response of the mobile control unit in the case where the response of a first mobile device is present according to a second embodiment;

FIG. 4B is a time chart showing the correspondence between the inquiry of the vehicle control unit and the response of the mobile control unit in the case where the response of a fourth mobile device is present according to the second embodiment;

FIG. 5 is a flowchart showing control contents performed by the vehicle control unit according to the second embodiment;

FIG. 6 is a block diagram showing the configuration of a smart key system according to a third embodiment;

FIG. 7A is a time chart showing the correspondence between the inquiry of the vehicle control unit and the response of the mobile control unit in the case where the response of a first mobile device is present according to the third embodiment;

FIG. 7B is a time chart showing the correspondence between the inquiry of the vehicle control unit and the response of the mobile control unit in the case where the response of a fourth mobile device is present according to the third embodiment;

FIG. 8 is a flowchart showing control contents performed by the vehicle control unit according to the third embodiment;

FIG. 9A is a time chart showing the correspondence between the inquiry of the vehicle control unit and the response of the mobile control unit in the case where the response of a first mobile device is present according to a fourth embodiment;

FIG. 9B is a time chart showing the correspondence between the inquiry of the vehicle control unit and the response of the mobile control unit in the case where the response of a fourth mobile device is present according to the fourth embodiment;

FIG. 10A is a time chart showing the correspondence between the inquiry of the vehicle control unit and the response of the mobile control unit in the case where the response of a first mobile device is present according to a fifth embodiment; and

FIG. 10B is a time chart showing the correspondence between the inquiry of the vehicle control unit and the response of the mobile control unit in the case where the response of a fourth mobile device is present according to the fifth embodiment.

### DESCRIPTION OF EMBODIMENTS

Hereinafter, a plurality of embodiments of the present disclosure will be described with reference to the drawings. In each embodiment, sections corresponding to items described in the preceding embodiment are denoted by the same reference numerals, and their repetitive description might be omitted. In each embodiment, in the case where only a part of a configuration is described, the precedingly described embodiment can be applied to the other part of the configuration. It is possible not only to combine parts that can be explicitly combined in the embodiments, but also to partially combine the embodiments even if not explicitly specified if there is no trouble with the combination.

### First Embodiment

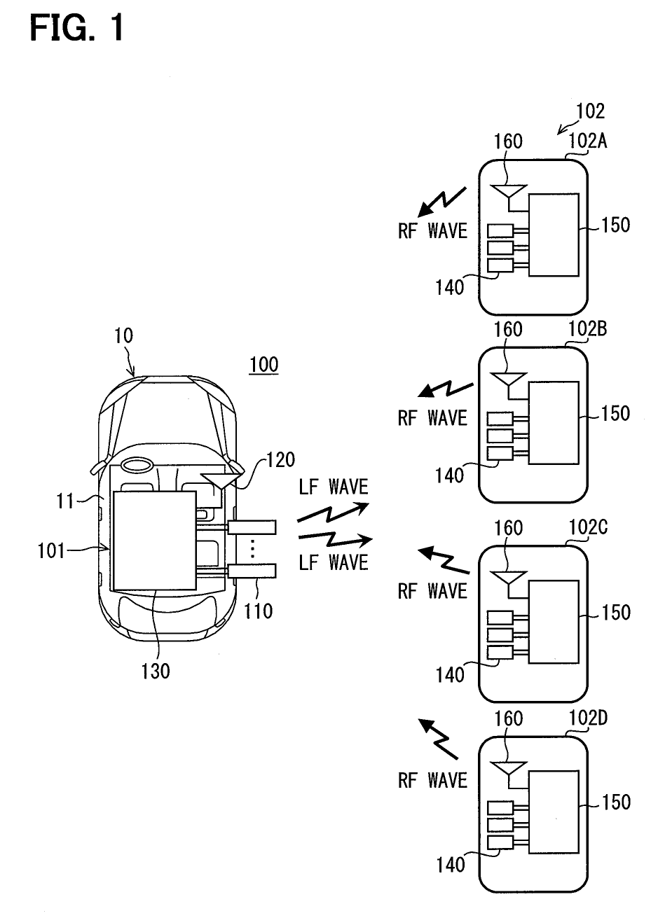

A smart key system 100 according to a first embodiment will be described with reference to FIGS. 1 to 3. The smart key system 100 according to the first embodiment is a system that enables the locking or unlocking of a door 11 without directly inserting a key into the key cylinder of the door 11 of a vehicle 10. The door 11 corresponds to an opening/closing body. In the smart key system 100, in a state (unlocked state) where the door 11 is not locked, for example, when a user carrying a mobile device 102 touches a predetermined part of the handle of the door 11, the door 11 is locked. Further, in a state (locked state) where the door 11 is locked, for example, when the user carrying the mobile device 102 touches the predetermined part of the handle of the door 11 or touches the knob in the manner of griping the handle, or approaches the vehicle 10 at a predetermined distance, the door 11 is unlocked.

The smart key system 100 includes a vehicle-side main body unit 101 and the mobile device 102, as shown in FIG. 1. In this embodiment, the mobile device 102 is set as a plurality of (four) mobile devices 102A, 102B, 102C, and 102D. The number of mobile devices 102 is not limited to four.

The vehicle-side main body unit 101 is provided near the handle of the door 11 of the vehicle 10, and includes a main body transmission unit 110, a main body reception unit 120, a main body control unit 130, and the like

The main body transmission unit 110 is a transmission unit that transmits an inquiry signal to each of the mobile devices 102A to 102D outside the vehicle, by wireless communication, using an LF (Low Frequency) wave as a long wave. The main body transmission unit 110 is formed as a transmitting antenna that transmits the inquiry signal.

The main body reception unit 120 is a reception unit that receives a response signal using an RF (Radio Frequency) wave as a high frequency wave transmitted from each of the mobile devices 102A to 102D. The main body reception unit 120 is formed as a receiving antenna that receives the response signal. The main body reception unit 120 outputs the received response signal to the main body control unit 130.

The main body control unit 130 is a control unit that outputs the inquiry signal to the main body transmission unit 110 and receives the response signal of each of the mobile devices 102A to 102D from the main body reception unit 120. When the user carrying at least one of the mobile devices 102A to 102D performs an operation (touching, gripping, approaching, or the like) on the handle of the door 11 at the time of locking or unlocking the door 11; with this operation as a trigger, the main body control unit 130 outputs the inquiry signal registered beforehand to the main body transmission unit 110. The inquiry signal is, for example, vehicle identification information ID for vehicle identification including mobile identification information IDA to IDD of each of the mobile devices 102A to 102D. The registered number (four in this embodiment) of mobile devices 102A to 102D set in the smart key system 100 is stored beforehand in the main body control unit 130.

The main body control unit 130 performs verification (simple verification and formal verification) of the response signal acquired from each of the mobile devices 102A to 102D, and outputs a command for locking or unlocking to the lock mechanism of the door 11, based on the result of the verification. The main body control unit 130 performs simple verification of each of the mobile devices 102A to 102D in predetermined order. The predetermined order is, for example, the order of the mobile devices 102A, 102B, 102C, and 102D.

Meanwhile, each of the mobile devices 102A to 102D is a mobile key that can be carried by the user. For example, one of the mobile devices 102A to 102D is a main mobile device 102A, and the rest are spare mobile devices 102B to 102D. The mobile devices 102A to 102D are used, for example, within a family (father, mother, son, daughter, etc.).

The vehicle 10 is started, operated, and stopped by any one of the mobile devices 102A to 102D that is carried by a driver. At this time, among the remaining mobile devices, there are cases where all the rest are carried with passengers, some of the rest are carried with passengers, or none of the rest is carried due to no passenger.

Each of the mobile devices 102A to 102D includes a mobile reception unit 140, a mobile control unit 150, and a mobile transmission unit 160, and the like.

The mobile reception unit 140 is a reception unit that receives the inquiry signal transmitted from the main body transmission unit 110 and outputs the inquiry signal to the mobile control unit 150. The mobile reception unit 140 is formed as a receiving antenna that receives the inquiry signal.

The mobile control unit 150 is a control unit that outputs the response signal required for verification to the mobile transmission unit 160, based on the inquiry signal inputted from the mobile reception unit 140. The response signal is a signal registered (assigned) beforehand in the mobile control unit 150, and is, for example, the mobile identification information IDA to IDD including the vehicle identification information ID of the vehicle 10. The mobile identification information IDA to IDD of each of the mobile devices 102A to 102D is composed of the mobile identification information IDA for the mobile device 102A, the mobile identification information IDB for the mobile device 102B, the mobile identification information IDC for the mobile device 102C, and the mobile identification information IDD for the mobile device 102D. Each of the mobile identification information IDA to IDD corresponds to unique identification information.

The mobile transmission unit 160 is a transmission unit that transmits the response signal from the mobile control unit 150 to the main body reception unit 120. The mobile transmission unit 160 is formed as an antenna that transmits the response signal.

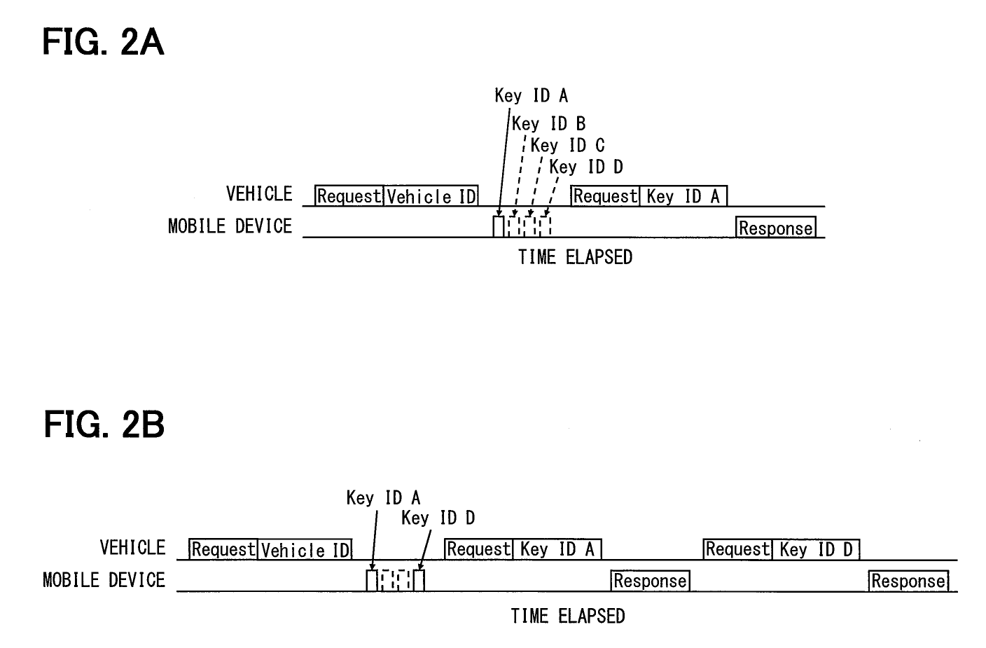

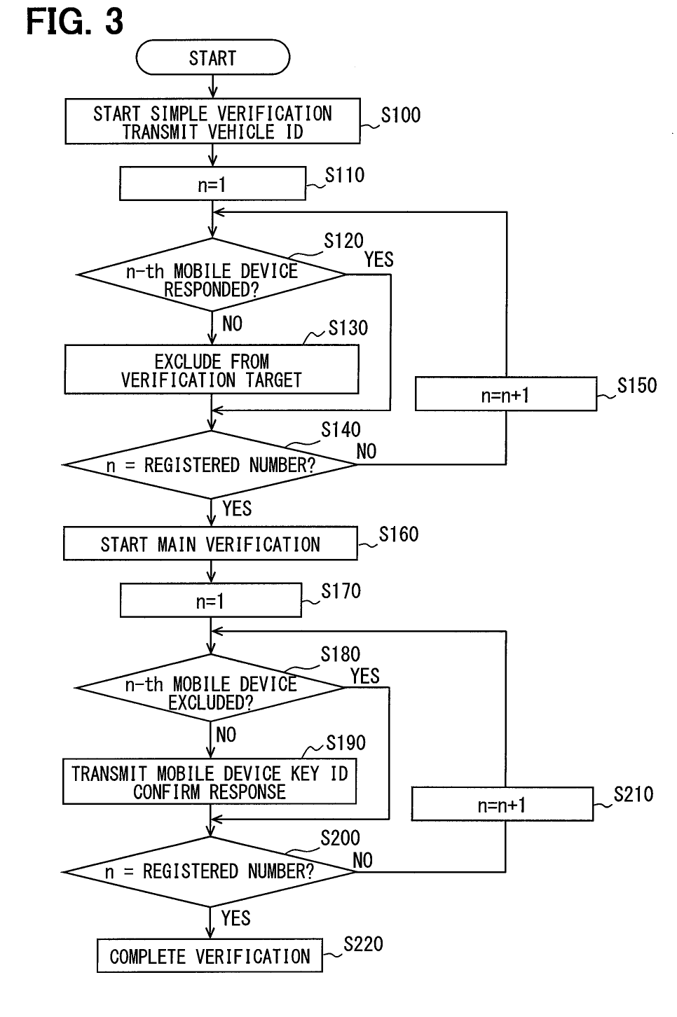

Next, the operation of the smart key system 100 configured as above will be described with reference to time charts in FIGS. 2A and 2B and a flowchart in FIG. 3. The flowchart in FIG. 3 shows control contents performed by the main body control unit 130.

In the smart key system 100, at the time of locking or unlocking, the main body control unit 130 first performs simple verification for confirming the presence or absence of each of the mobile devices 102A to 102D within a response area, before verifying the mobile identification information IDA to IDD from each of the mobile devices 102A to 102D. Then, the main body control unit 130 performs formal verification of the mobile identification information (IDA to IDD) for mobile devices that have been confirmed to be present within the response area by the simple verification, among the mobile devices 102A to 102D.

The response area is an area within which the mobile control unit 150 (each of the mobile devices 102A to 102D) can respond to the inquiry signal from the main body transmission unit 110, and is the area of a reachable range (e.g., a range of about 5 m) of the inquiry signal from the main body control unit 130. In the use of the vehicle 10, among the mobile devices 102A to 102D, mobile devices that are carried at the place (near the vehicle 10) are present within the response area, and mobile devices that are not carried are not present within the response area.

First, in FIGS. 2A, 2B, and 3, for example, at the time of locking the door 11, the user touches the predetermined part of the handle of the door 11. Then, in S100, the main body control unit 130 transmits, from the main body transmission unit 110, vehicle authentication information ID as the inquiry signal for starting simple verification to each of the mobile devices 102A to 102D. The state of this transmission corresponds to the indication of “Request Vehicle ID” in FIGS. 2A and 2B. In the simple verification, each of the mobile devices 102A to 102D responds to the inquiry signal from the main body control unit 130 in the predetermined order (the order of the mobile devices 102A to 102D).

Then, in S110, the main body control unit 130 sets n=1 as a count number for counting the mobile devices 102A to 102D. The count number corresponds to the registered number of mobile devices 102A to 102D. Since the number of mobile devices 102A to 102D is set to four in this embodiment, the count number ranges from n=1 to 4. The order of n=1 to 4 is predetermined so as to correspond to the order of the mobile devices 102A to 102D.

Then, in S120, the main body control unit 130 determines whether a response from the n-th mobile device to the inquiry signal in S100 is present or absent. If the main body control unit 130 determines that the response is absent, the n-th mobile device is not present within the response area, so that the main body control unit 130 proceeds to S130, and excludes this mobile device from the target of formal verification described below. If the main body control unit 130 determines that the response is present, the n-th mobile device is present within the response area, so that the main body control unit 130 skips S130 and proceeds to S140.

Then, in S140, the main body control unit 130 determines whether or not the count number reaches the registered number of mobile devices 102A to 102D. If No, the main body control unit 130 proceeds to S150, updates the count number to n=n+1, returns to S120, and repeats S120 to S150.

That is, until the count number reaches n=4 (registered number) from n=1, the main body control unit 130 sequentially determines whether or not a response to the simple verification is present, that is, sequentially confirms the presence or absence of each of the mobile devices 102A to 102D within the response area, and excludes the mobile device that has made no response (not present within the response area) from the target of formal verification.

The state of the response of each of the mobile devices 102A to 102D corresponds to the indication of “Key IDA to Key IDD” in FIGS. 2A and 2B. In the case of FIG. 2A, the mobile device that has made the response (present within the detection area) is only the mobile device 102A, and the mobile devices 102B, 102C, 102D are excluded from the target of the following formal verification. In the case of FIG. 2B, the mobile devices that have made the response (present within the detection area) are the mobile devices 102A and 102D, and the mobile devices 102B and 102C are excluded from the target of the following formal verification.

If the main body control unit 130 determines in S140 that the count number n reaches the registered number, in S160 the main body control unit 130 starts formal verification (main verification). The formal verification is performed, excluding the mobile devices that have made no response in the simple verification.

First, in S170, the main body control unit 130 sets n=1 as the count number for the mobile devices 102A to 102D, as in S110.

Then, in S180, the main body control unit 130 determines whether or not the n-th mobile device is excluded from the target of the formal verification in S130. If the n-th mobile device is not excluded, the main body control unit 130 proceeds to S190, where the main body control unit 130 transmits a signal for requesting the mobile identification information (IDA to IDD) to the n-th mobile device, and confirms a response from the nth mobile device. If the n-th mobile device is excluded, the main body control unit 130 skips S190 and proceeds to S200.

Then, in S200, the main body control unit 130 determines whether or not the count number reaches the registered number of mobile devices 102A to 102D. If No, the main body control unit 130 proceeds to S210, updates the count number to n=n+1, returns to S180, and repeats S180 to S210. That is, until the count number reaches n=4 (registered number) from n=1, the main body control unit 130 excludes the mobile devices that have made no response in the simple verification from the target of the formal verification, transmits the mobile identification information (IDA to IDD) to the mobile devices that have made the response, and performs the response confirmation (formal verification). Then, if Yes in S200, in S220 the main body control unit 130 completes the verification.

The state of the formal verification of the mobile devices that have made the response in the simple verification among the mobile devices 102A to 102D corresponds to the indication of “Request Key ID” and “Response” in FIGS. 2A and 2B. The main body control unit 130 sequentially performs the formal verification of the mobile devices that have made the response in the simple verification while omitting the mobile devices that have made no response in the simple verification. In FIG. 2A, the formal verification is performed only on the mobile device 102A that has made the response in the simple verification. In FIG. 2B, the formal verification is sequentially performed on the mobile devices 102A and 102D that have made the response in the simple verification.

Then, if the formal verification is established, the main body control unit 130 outputs a command for locking to the lock mechanism of the door 11. Further, at the time of unlocking the door 11, the main body control unit 130 performs the same control as above.

Thus, in this embodiment, the main body control unit 130 first performs the simple verification, and thereby confirms the presence or absence of the plurality of mobile devices 102A to 102D within the response area. Then, the main body control unit 130 performs the formal verification of the mobile devices that have been confirmed to be present by the simple verification, among the plurality of mobile devices 102A to 102D. Therefore, if there is a mobile device that is not present within the response area, the formal verification for that is omitted, and the verification time for that can be reduced, so that the total time until the completion of the verification can be reduced.

Since the formal verification is performed omitting mobile the devices that have not been confirmed to be present within the response area, it is possible to surely reduce the verification time.

Further, since the simple verification is performed on the mobile devices 102A to 102D in the predetermined order, the mobile devices 102A to 102D do not transmit the response signal at the same time, and it is possible to perform the simple verification without interference.

### First Modification of First Embodiment

In the description of the first embodiment, the predetermined order is used for the simple verification of the mobile devices 102A to 102D. However, instead of this, the main body control unit 130 may store the result of the inquiry (the record of the presence or absence of the response from the mobile device) each time, and the order of the simple verification may be set in descending order of the presence probability of the mobile device within the response area based on the previous inquiries. As the previous data items, it is possible to use a plurality of past data items, the latest data item, or the like.

Further, the order of the formal verification can be determined in the descending order of the presence probability, and the verification can be performed, omitting the mobile devices that have made no response.

In the predetermined order as in the first embodiment, for example in the case where the most frequently used mobile device is the mobile device 102D, the formal verification is performed on the mobile device 102D always in the last place; therefore, the availability of the mobile device 102D is established at the last part of the overall verification time. In contrast, by giving higher priority to the verification of the mobile device having a higher presence probability based on the previous data items, the availability of the mobile device is verified at earlier timing, so that the mobile device can be used immediately.

### Second Modification of First Embodiment

Further, the order of each of the mobile devices 102A to 102D in the simple verification may be order that is set by raising the priority order of the mobile device that has been present within the response area based on the previous inquiry, with respect to the first embodiment and the first modification.

### Second Embodiment

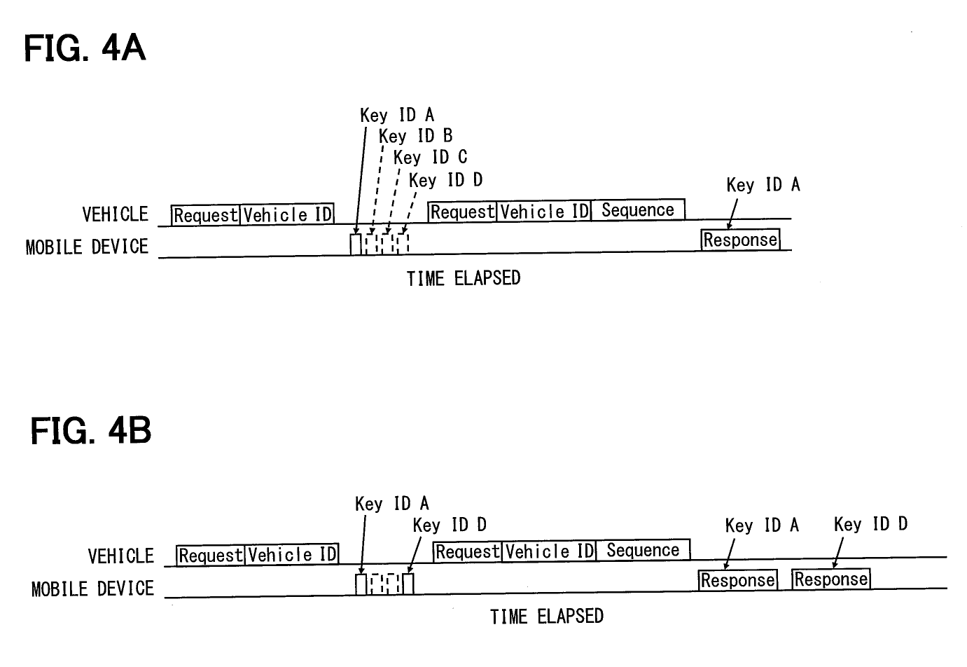

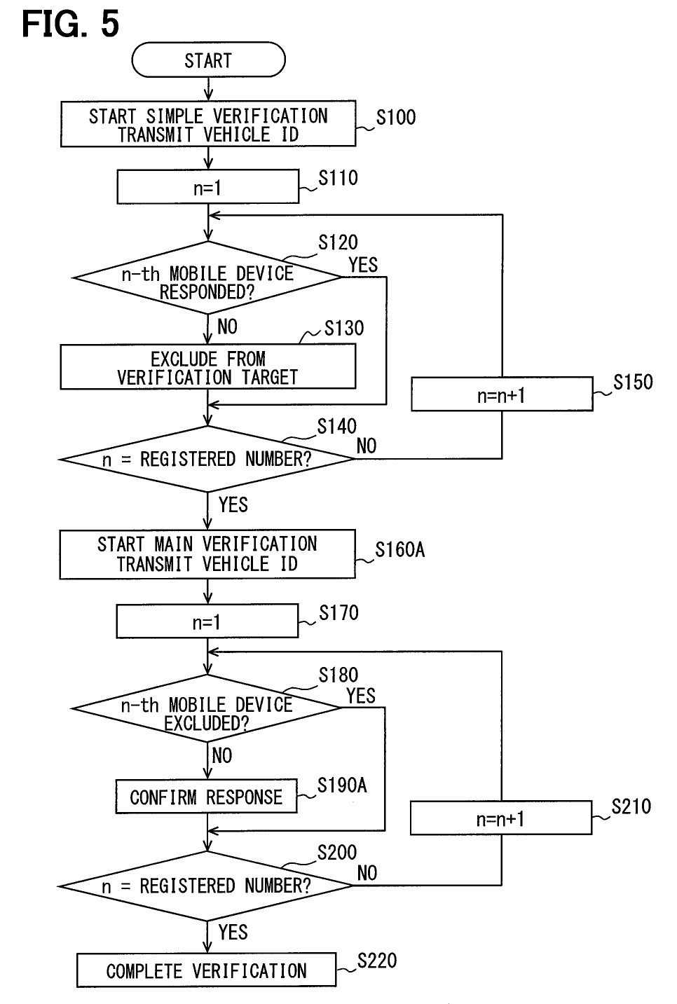

FIGS. 4A, 4B, and 5 show a second embodiment. In the second embodiment, while the configuration of the smart key system 100 is the same as in the first embodiment, a part of the control contents performed by the main body control unit 130 is changed. In a flowchart shown in FIGS. 5, S160 and S190 in the flowchart of FIG. 3 in the first embodiment are changed to S160A and S190A.

As shown in FIG. 5, after performing S100 to S150 as in the first embodiment, the main body control unit 130 starts formal verification in S160A. At this time, the main body control unit 130 first transmits vehicle authentication information ID specifying the order of responses, to the formal verification, from mobile devices that have made the response in S120.

The state of this transmission corresponds to the indication of “Request Vehicle ID Sequence” in FIGS. 4A and 4B. “Sequence” is an instruction indicating the order of the response.

Then, during S170 to S210, the main body control unit 130 confirms, in S190A, the responses from the mobile devices present within the detection area in the order of the responses specified in S160A.

It is thereby possible to obtain the same effect as in the first embodiment. In this embodiment, since the order of the responses from the mobile devices present within the detection area is specified first at the time of the formal verification, it is not necessary to issue an instruction for requesting the mobile identification information (IDA to IDD) to each mobile device each time as in the first embodiment.

### Third Embodiment

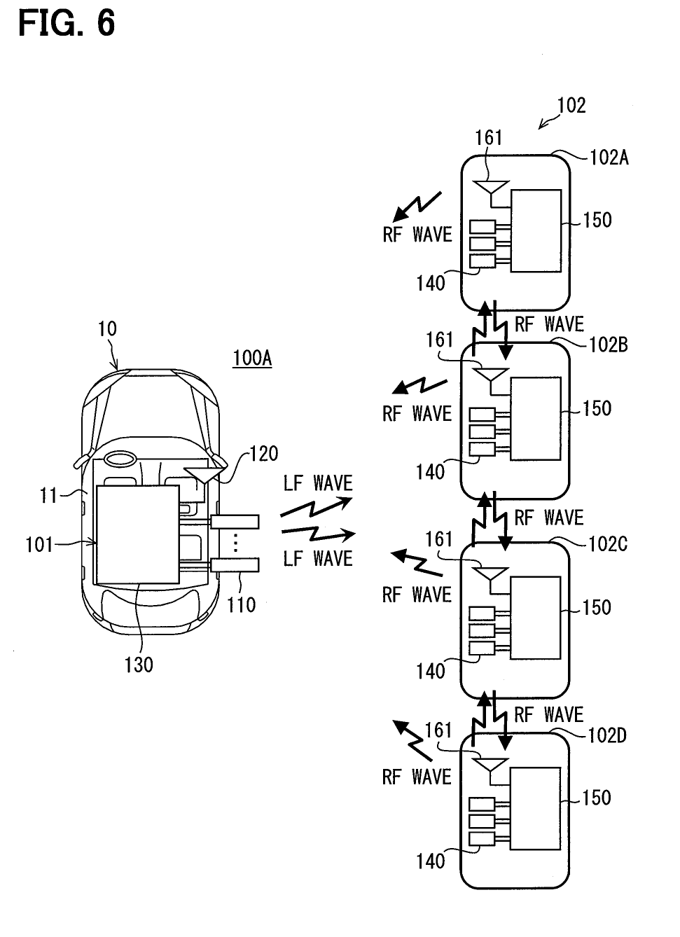

FIGS. 6 to 8 show a smart key system 100A according to a third embodiment. In the third embodiment, the mobile transmission unit 160 of each of the mobile devices 102A to 102D in the first embodiment is changed to a mobile transmission/reception unit 161.

As shown in FIG. 6, the mobile transmission/reception unit 161 is a transmission/reception unit that transmits the response signal to the main body control unit 130 (main body reception unit 120) and enables intercommunication between the mobile devices 102A to 102D, using an RF wave. That is, each of the mobile devices 102A to 102D receives a response content transmitted from another mobile device to the main body control unit 130, and thereby can share the response content.

Further, each of the mobile devices 102A to 102D (each mobile control unit 150) responds to the main body control unit 130 in predetermined order (response order). The response order is, for example, that the mobile device 102A is the first, the mobile device 102B is the second, the mobile device 102C is the third, and the mobile device 102D is the fourth.

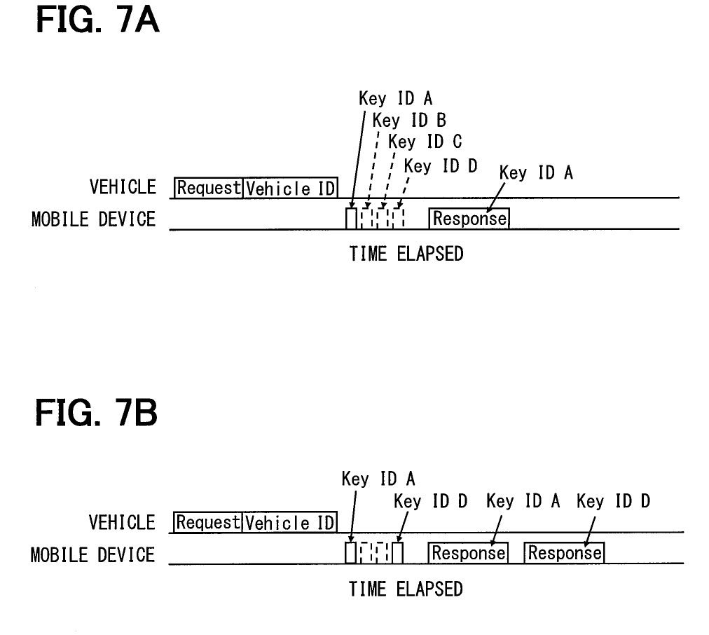

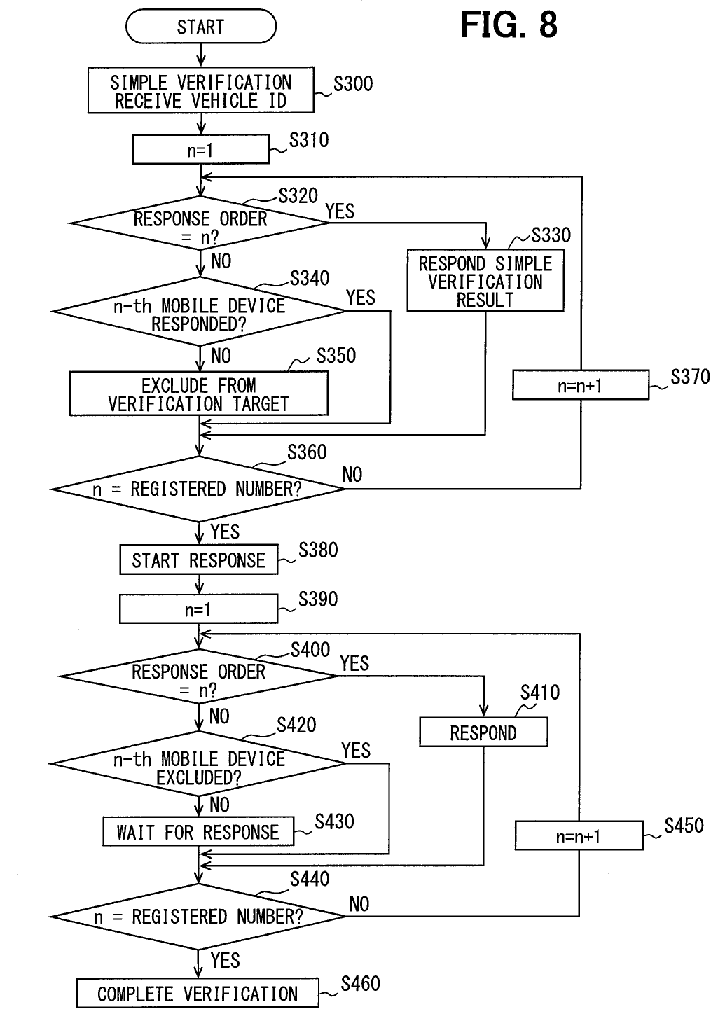

The operation of the smart key system 100A of the present embodiment will be described with reference to time charts in FIGS. 7A and 7B and a flowchart in FIG. 8. The flowchart in FIG. 8 shows control contents performed by the mobile control unit 150 of each of the mobile devices 102A to 102D.

First, in S300, each mobile control unit 150 receives vehicle authentication information ID as an inquiry signal for starting simple verification (simple response) from the main body control unit 130. The order of the response of each of the mobile devices 102A to 102D is specified in the vehicle authentication information ID. The inquiry signal from the main body control unit 130 corresponds to the indication of “Request Vehicle ID” in FIGS. 7A and 7B.

Next, in S310, each mobile control unit 150 sets n=1 as a count number for counting the mobile devices 102A to 102D. As in the first embodiment, the count number corresponds to the registered number of mobile devices 102A to 102D. Since the number of mobile devices 102A to 102D is set to four in this embodiment, the count number ranges from n=1 to 4.

Then, in S320, each mobile control unit 150 determines whether or not the set n is equal to its own response order. Among the mobile control units 150, the mobile control unit 150 determining in S320 that its own response order is equal to n proceeds to S330.

In S330, the mobile control unit 150 corresponding to the response order, if present within the detection area, responds to the simple verification from the main body control unit 130. However, if the mobile device (mobile control unit) corresponding to the response order n is not present within the detection area, the mobile device cannot respond to the main body control unit 130, as a matter of course. The flow proceeds to S360 after S330.

In contrast, the mobile control unit 150 determining in S320 that the set n is not its own response order determines in S340 whether or not the n-th mobile device has made the simple response. If No in S340, in S350 the n-th mobile device is excluded from the target of verification (formal response). If Yes in S340, the flow skips S350 and proceeds to S360.

In S360, each mobile control unit 150 determines whether or not the count number reaches the registered number of mobile devices 102A to 102D. If No, each mobile control unit 150 proceeds to S370, updates the count number to n=n+1, returns to S320, and repeats S320 to S370.

That is, each mobile control unit 150, if present within the detection area, performs the simple response in accordance with the predetermined response order until the count number reaches n=4 (registered number) from n=1. At this time, the other mobile control units 150 not corresponding to the response order grasp by intercommunication whether or not the mobile control unit 150 corresponding to the response order has performed the simple response. As a matter of course, the mobile device (mobile control unit) that is not present within the detection area cannot respond. Accordingly, the other mobile control units 150 not corresponding to the response order grasp by intercommunication the mobile control unit making no response, and exclude it from the target of the response (formal response) to the main body control unit 130.

The state of the response of each of the mobile devices 102A to 102D corresponds to the indication of “Key IDA to Key IDD” in FIGS. 7A and 7B. In the case of FIG. 7A, the mobile device that has made the response (present within the detection area) is only the mobile device 102A, and the mobile devices 102B, 102C, 102D are excluded from the target of the following formal response. In the case of FIG. 7B, the mobile devices that have made the response (present within the detection area) are the mobile devices 102A and 102D, and the mobile devices 102B and 102C are excluded from the target of the following formal response.

Then, in S380, each mobile control unit 150 starts the formal response.

First, in S390, each mobile control unit 150 sets n=1 as the count number for counting the mobile devices 102A to 102D, as in S310.

Then, in S400, each mobile control unit 150 determines whether or not the set n is equal to its own response order. Among the mobile control units 150, the mobile control unit 150 determining in S400 that its own response order is equal to n proceeds to S410.

In S410, the mobile control unit 150 corresponding to the response order, if present within the detection area, performs the formal response to the main body control unit 130. However, if the mobile device (mobile control unit) corresponding to the response order n is not present within the detection area, the mobile device cannot respond to the main body control unit 130, as a matter of course. The flow proceeds to S440 after S410. At this time, the other mobile control units 150 grasp by intercommunication whether or not the mobile control unit 150 corresponding to the response order has made the response.

In contrast, the mobile control unit 150 determining in S400 that the set n is not its own response order determines in S420 whether or not the n-th mobile device is excluded from the target of the formal response. That is, the mobile control unit 150 determining that the set n is not its own response order exclude, from the target of the formal response, the mobile control unit that has made no response in S410, and keeps, in the target of the formal response, the mobile control unit that has made the response in S410.

If No in S420, the mobile control unit 150 determining that the set n is not its own response order waits for the formal response in S430. If Yes in S420, the flow skips S430 and proceeds to S440.

In S440, each mobile control unit 150 determines whether or not the count number reaches the registered number of mobile devices 102A to 102D. If No, each mobile control unit 150 proceeds to S450, updates the count number to n=n+1, returns to S400, and repeats S400 to S450.

That is, each mobile control unit 150 performs the formal response in accordance with the predetermined response order until the count number reaches n=4 (registered number) from n=1. At this time, the mobile control unit 150 corresponding to the response order performs the formal response if it is present within the detection area, and does not (cannot) perform the formal response if it is not present within the detection area. The other mobile control units 150 not corresponding to the response order grasp by intercommunication whether or not the mobile control unit 150 corresponding to the response order has performed the formal response. Therefore, if the formal response is present, the next mobile control unit waits for the response. If the formal response is absent, the mobile control unit making no response is excluded from the target of the formal response, and then the next response is performed. Then, if Yes in S440, in S460 each mobile control unit 150 completes the verification (formal response).

The state of the formal response of the mobile devices that have made the simple response among the mobile devices 102A to 102D corresponds to the indication of “Response” in FIGS. 7A and 7B. Each mobile control unit 150 performs the formal response in order in which the mobile devices that have made no response in the simple response are omitted. In FIG. 7A, only the mobile device 102A that has made the simple response performs the formal response. In FIG. 7B, the mobile devices 102A and 102D that have made the simple response sequentially perform the formal response.

Then, if the verification by the formal response is established, the main body control unit 130 outputs a command for locking to the lock mechanism of the door 11. Further, at the time of unlocking the door 11, the main body control unit 130 performs the same control as above.

Thus, in this embodiment, when the inquiry is made from the main body control unit 130, the plurality of mobile devices 102A to 102D sequentially perform the simple response, to the main body control unit 130, indicating the presence or absence within the response area. Then, the plurality of mobile devices 102A to 102D perform the formal response to the inquiry in the order in which the mobile devices making no simple response, obtained based on intercommunication, are omitted. Therefore, if there is a mobile device that is not present within the response area, the formal verification for the mobile device that is not present within the response area is omitted, and the verification time for that can be reduced, so that the total time until the completion of the verification can be reduced.

### Fourth Embodiment

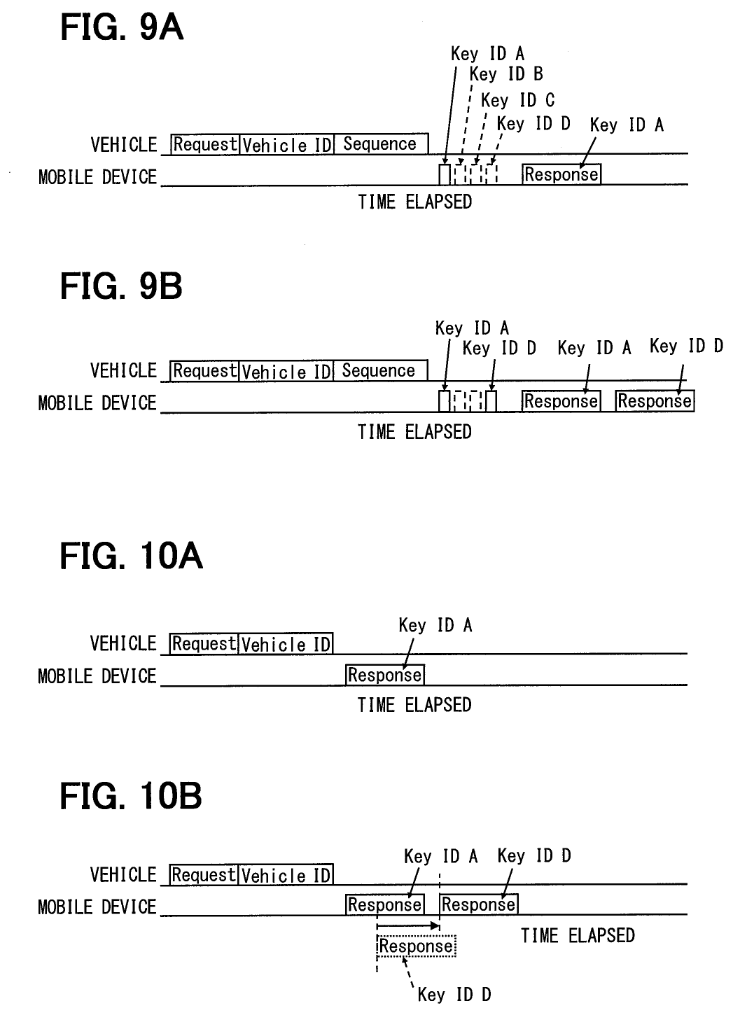

FIGS. 9A and 9B show a fourth embodiment. In the fourth embodiment, with respect to the third embodiment, the main body control unit 130 specifies the order of the response of each of the mobile devices 102A to 102D in advance at the time of performing an inquiry to each of the mobile devices 102A to 102D.

The main body control unit 130 first transmits vehicle authentication information ID specifying the order of the response to the inquiry. Each mobile control unit 150 performs the simple response and the formal response, based on the order of the response. At this time, if there is a mobile device that is not present within the detection area, the response is performed in response order in which the mobile device is omitted.

The state of the first transmission of the main body control unit 130 corresponds to the indication of “Request Vehicle ID Sequence” in FIGS. 9A and 9B. “Sequence” is an instruction indicating the order of the response.

The state of the simple response of each mobile control unit 150 corresponds to the indication of “Key IDA to Key IDD” in FIGS. 9A and 9B. The mobile devices that are not present within the detection area make no response, and are indicated by broken lines. The state of the formal response of each mobile control unit 150 corresponds to the indication of “Response (Key IDA to Key IDD)” in FIGS. 9A and 9B. The response is performed in a state where the mobile devices that are not present within the detection area are omitted.

It is thereby possible to obtain the same effect as in the third embodiment.

### Fifth Embodiment

FIGS. 10A and 10B show a fifth embodiment. In the fifth embodiment, with respect to the first embodiment, the procedure of the response, to the inquiry from the main body control unit 130, of each of the mobile devices 102A to 102D is preset.

As in the third embodiment, each of the mobile devices 102A to 102D has the mobile transmission/reception unit 161, which enables intercommunication between the mobile devices 102A to 102D. Each of the mobile devices 102A to 102D receives a response content transmitted from another mobile device to the main body control unit 130, and thereby can share the response content.

The order is specified beforehand in such a manner that the mobile devices 102A to 102D each respond to the inquiry of the main body control unit 130 with a predetermined delay time (a predetermined time difference). For example, the response order is the order of the mobile devices 102A, 102B, 102C, and 102D. The mobile device 102B is set so as to respond with the predetermined delay time from the response time of the mobile device 102A. In the same way, the mobile device 102C is set so as to respond with the predetermined delay time from the response time of the mobile device 102B, and the mobile device 102D is set so as to respond with the predetermined delay time from the response time of the mobile device 102C.

For example, the total sum of the delay time of the mobile device 102B, the delay time of the mobile device 102C, and the delay time of the mobile device 102D is set shorter than the time required for the response of the mobile device 102A.

Each of the mobile devices 102A to 102D responds to the inquiry of the main body control unit 130, based on the above order. When the preceding mobile device is during the response, the subsequent mobile device waits for a predetermined time and then responds so as not to overlap with the preceding mobile device.

That is, as shown in FIG. 10A, for example, if the mobile device 102A is present within the detection area, the mobile device 102A responds to the inquiry from the main body control unit 130, with the mobile identification information IDA. As shown in FIG. 10B, for example, if the mobile devices 102A and 102D are present within the detection area, the mobile device 102A responds first, the mobile device 102B does not respond for the lapse of the predetermined delay time from the response start of the mobile device 102A, the mobile device 102C does not respond, and then the mobile device 102D responds.

At this time, after waiting for the respective predetermined delay times of the mobile devices 102B and 102C, the mobile device 102D is supposed to respond as shown by “Response” of a broken line in FIG. 10B. However, if the mobile device 102A is during the response (since the mobile device 102A is during the response) at this timing—the mobile device 102D waits for the predetermined time and then responds so as not to overlap with the response of the mobile device 102A.

Thus, in the present embodiment, since the order of the response of each of the mobile devices 102A to 102D is specified, if there is a mobile device that is not present within the response area, the response by the mobile device is automatically omitted, so that the total time until the completion of the verification can be reduced.

Further, when the mobile device that is lower in the specified order responds based on the order, if the mobile device that is higher in the order is during the response, the mobile device that is lower in the order waits for the predetermined time and then responds so as not to overlap with the mobile device that is higher in the order. Therefore, the main body control unit 130 can surely obtain the response result without interference between mobile devices present within the detection area.

The order of the response, to the inquiry of the main body control unit 130, of each of the mobile devices 102A to 102D is not limited to the order specified beforehand as above. For example, as in the first modification, the response order may be the descending order of the presence probability of the mobile device within the response area based on the previous inquiries. Alternatively, for example, as in the second modification, the response order may be the order that is set by raising the priority order of the mobile device that has been present within the response area based on the previous inquiry.

### OTHER EMBODIMENT

In the above embodiments, the smart key systems 100 and 100A are applied to the locking or unlocking of the door 11 of the vehicle 10, but, not limited thereto, may be applied to e.g. a door or the like for a house.

What is claimed is:

1. A smart key system comprising:
a plurality of mobile devices each of which can be carried by a user, and is assigned unique identification information; and
a control unit that is provided in an opening/closing body, performs an inquiry to the plurality of mobile devices by radio wave transmission, and locks or unlocks the opening/closing body when verification of the identification information responded from any of the mobile devices succeeds, wherein
the control unit performs simple verification to confirm presence or absence of the plurality of mobile devices within a response area, before the verification of the identification information, and performs the verification of the identification information, as a formal verification, for a mobile device that has been confirmed to be present by the simple verification, among the plurality of mobile devices.

2. The smart key system according to claim 1, wherein
the simple verification is performed for the plurality of mobile devices in a predetermined order.

3. The smart key system according to claim 1, wherein
the simple verification is performed for the plurality of mobile devices in a descending order of presence probability of each of the mobile devices within the response area based on the previous inquiries.

4. The smart key system according to claim 1, wherein
the simple verification is performed for the plurality of mobile devices in an order that is set by raising priority order of a mobile device that has been present within the response area based on the previous inquiry.

5. The smart key system according to claim 1, wherein
the control unit sequentially performs the formal verification of the identification information while omitting a mobile device that has not been confirmed to be present within the response area.

6. The smart key system according to claim 1, wherein
in the formal verification of the identification information, the control unit specifies an order of the mobile devices that have been confirmed to be present within the response area, and sequentially acquires a response to the inquiry from the mobile devices whose order are specified.

7. A smart key system comprising:
a plurality of mobile devices each of which can be carried by a user, and is assigned unique identification information; and
a control unit that is provided in an opening/closing body, performs an inquiry to the plurality of mobile devices by radio wave transmission, and locks or unlocks the opening/closing body when verification of the identification information responded from any of the mobile devices succeeds, wherein
each of the plurality of mobile devices enables intercommunication by which a response content responded from another mobile device to the control unit is received, and
when the inquiry is made from the control unit, the plurality of mobile devices sequentially perform a simple response, to the control unit, indicating presence or absence within a response area, grasp by intercommunication a mobile device making no simple response, and perform a formal response to the inquiry in order in which the mobile device making no response is omitted.

8. The smart key system according to claim 7, wherein
the plurality of mobile devices performs the simple response in a predetermined order.

9. The smart key system according to claim 7, wherein
the plurality of mobile devices performs the simple response in an order that is specified by the control unit at the time of the inquiry.

10. A smart key system comprising:
a plurality of mobile devices each of which can be carried by a user, and is assigned unique identification information; and
a control unit that is provided in an opening/closing body, performs an inquiry to the plurality of mobile devices by radio wave transmission, and locks or unlocks the opening/closing body when verification of the identification information responded from any of the mobile devices succeeds, wherein
each of the plurality of mobile devices enables intercommunication by which a response content responded from another mobile device to the control unit is received,
an order that the plurality of mobile devices respond to the inquiry from the control unit is specified beforehand in such a manner that the plurality of mobile devices respond to the inquiry from the control unit with a predetermined time difference, and
in a case where a mobile device that is lower in the order responds based on the order during a response of a mobile device that is higher in the order, the mobile device that is lower in the order waits for a predetermined time and then responds so as not to overlap with the mobile device that is higher in the order.

11. The smart key system according to claim 10, wherein
the order that the plurality of mobile devices respond to the inquiry from the control unit is a predetermined order.

12. The smart key system according to claim 10, wherein
the order that the plurality of mobile devices respond to the inquiry from the control unit is a descending order of presence probability of each of the mobile devices within a response area based on the previous inquiries.

13. The smart key system according to claim 10, wherein
the order that the plurality of mobile devices respond to the inquiry from the control unit is an order that is set by raising priority order of the mobile device that has been present within a response area based on the previous inquiry.
